(19) United States
(12) Patent Application Publication
(10) Pub. No.: US 2007/0046210 A1
(43) Pub. Date: Mar. 1, 2007

(54) Electrode terminal structure and plasma display panel employing the same

(76) Inventor: Jae-Young An, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/512,505

(22) Filed: Aug. 29, 2006

(30) Foreign Application Priority Data
Aug. 30, 2005 (KR) 10-2005-0080023

(51) Int. Cl. H01J 17/49

(52) U.S. Cl. 313/583; 313/582

(57) ABSTRACT

An electrode terminal structure in which an electrical short does not occur between terminal electrodes included in electrode terminal portions and has a connecting region between the terminal electrodes and a signal transmission unit that can be easily designed, and a plasma display panel employing the electrode terminal structure, are disclosed. In one embodiment the electrode terminal structure includes: first electrodes, each including a plurality of bus electrodes; second electrodes that correspond to the first electrodes and include a plurality of bus electrodes. It may further include terminal electrodes which extend as single lines, each connecting to the bus electrodes included in one of the first and second electrodes.

### CROSS-REFERENCE TO RELATED PATENT APPLICATION

This application claims the benefit of Korean Patent Application No. 10-2005-0080023, filed on Aug. 30, 2005, in the Korean Intellectual Property Office, the disclosure of which is incorporated herein in its entirety by reference.

### BACKGROUND OF THE INVENTION

1. Field of the Invention

The present invention relates to an electrode terminal structure and a plasma display panel employing the electrode terminal structure, and more particularly, to an electrode terminal structure in which an electrical short does not occur between terminal electrodes in an electrode terminal and a simple design can be used in a connecting portion between the terminal electrode and a signal transmission unit, and a plasma display panel employing the same.

2. Description of the Related Technology

A plasma display panel is a flat display panel that displays an image using gas discharge, and is advantageous due to its large screen size, extreme thinness, high resolution, and wide viewing angle.

A plasma display panel includes a first substrate and a second substrate separated from and facing the first substrate, discharge cells, which are spaces where discharges occur, and a plurality of electrodes to which power voltages are applied. Discharges occur in the discharge cells due to an alternating or direct voltage applied between the electrodes, and ultra-violet rays radiated from a discharge gas excites fluorescent substances to emit visible rays to display an image.

The plurality of electrodes includes address electrodes that generate address discharges and sustain electrodes that maintain the discharges. The electrodes are electrically connected to a driving circuit unit that generates electric signals for driving the plasma display panel by the signal transmission unit.

Each of the sustain electrodes includes a first electrode including a transparent electrode and a bus electrode, and a second electrode that generates an address discharge together with the address electrode.

The electrodes are electrically connected to a signal transmission unit via an electrode terminal.

Specifically, the plasma display panel is driven by applying a voltage from a driving circuit unit to the electrodes in response to an image signal, and, typically, the driving circuit unit is electrically connected to terminals of the electrodes, which cause discharges, via the signal transmission unit.

In the conventional plasma display panel, to connect a plurality of terminal electrodes disposed on electrode terminals to the signal transmission unit of a limited size, the distances between the terminal electrodes are reduced where the terminal electrodes are near the signal transmission unit.

Therefore, conventionally, the terminal electrodes on the electrode terminals can sometimes contact each other due to defects during manufacturing, resulting in an electrical short.

Furthermore, since design space is restricted where the terminal electrodes are connected to the signal transmission unit, manufacturing is more difficult and a defect rate is increased, and thus manufacturing costs are increased.

The transparent electrodes of the sustain electrodes are typically made of indium tin oxide (ITO) or the like, generate a discharge and function to increase visible light transmission. The bus electrodes of the sustain electrodes are made of metal such as silver (Ag) with low resistance to prevent a voltage drop and provide electric current to the transparent electrodes. However, when the sustain electrodes are formed with a two-layer structure including the transparent electrode and the bus electrode, the manufacturing costs are increased because of the costly transparent electrode, it is difficult to realize low-voltage driving because of high resistance of the transparent electrode, and the transparent electrode and the bus electrode must be exactly aligned, and therefore, the manufacturing yield is reduced.

To solve the above problems, recently, sustain electrodes have included only bus electrodes without transparent electrodes. To this end, techniques for lowering a discharge starting voltage, maximizing a discharge space, and increasing an aperture ratio corresponding to visible light transmission have been studied.

Specifically, when a first electrode and a second electrode which generate a sustain discharge are respectively formed as bus electrodes and are disposed along barrier ribs, the aperture ratio is increased to 100%, but the distance between the bus electrodes is excessively large, thereby highly increasing the discharge starting voltage.

On the other hand, if the distance between a pair of bus electrodes that generate a sustain discharge is reduced to lower the discharge starting voltage, the discharge space is reduced, and the aperture ratio is, therefore, reduced.

Alternatively, to lower the discharge starting voltage and maximize the discharge space, the distance between the bus electrodes may be narrowed and the width of the bus electrodes may be increased. However, in this case, the area of the discharge cell which is covered by the bus electrodes is increased, and thus the aperture ratio is considerably reduced.

### SUMMARY OF CERTAIN INVENTIVE ASPECTS

The present invention provides an electrode terminal structure which addresses the above mentioned concerns.

One embodiment is an electrode terminal structure of a plasma display panel. The electrode terminal structure includes a plurality of first electrodes, each electrode including a plurality of bus electrodes, and a plurality of second electrodes, disposed so as to correspond to the first electrodes, each of the second electrodes including a plurality of bus electrodes. The electrode terminal structure also includes a plurality of terminal electrodes which are electrically connected to the first electrodes and to the second electrodes, respectively, and which extend as single lines, each connected to the bus electrodes of one of the plurality of first electrodes or connected to the bus electrodes of one of the second electrodes. The width of each of the terminal electrodes is less than or equal to the sum of the widths of the bus electrodes to which each terminal electrode is connected.

Another embodiment is a plasma display panel including a first substrate, a second substrate which faces and is separated from the first substrate, a plurality of barrier ribs which are interposed between the first substrate and the second substrate, a plurality of discharge cells configured to contain a discharge and having a plurality of fluorescent layers which are disposed in the discharge cells, a plurality of sustain electrodes which are disposed between the first substrate and the second substrate, the sustain electrodes being configured to initiate a gas discharge in the discharge cells by an interaction between the sustain electrodes, where the plurality of sustain electrodes includes a plurality of first electrodes and a plurality of second electrodes, which each include a plurality of bus electrodes, and a plurality of terminal electrodes which are electrically connected to the first electrodes and to the second electrodes, respectively, and which extend as single lines. Each terminal electrode is connected to the bus electrodes of one of the first and second electrodes, the width of each of the terminal electrodes being less than or equal to the sum of the widths of the bus electrodes to which each terminal electrode is connected. The panel also includes fluorescent layers which are disposed in the discharge cells, and a discharge gas which is filled in the discharge cells.

An electrode terminal structure of a plasma display panel, the electrode terminal structure including a first electrode connecting to a plurality of discharge cells, and including a first plurality of bus electrodes, and a second electrode connecting to the plurality of discharge cells, and including a second plurality of bus electrodes, a plurality of terminal electrodes which are electrically connected to the first electrodes and to the second electrodes, respectively, and which extend as single lines, each connected to the bus electrodes of one of the plurality of first electrodes or connected to the bus electrodes of one of the second electrodes.

### BRIEF DESCRIPTION OF THE DRAWINGS

The above and other features and advantages of the present invention will become more apparent by referring to the attached drawings in which:

FIG. 1 is a perspective view of a plasma display panel according to an embodiment;

FIG. 2 is a partially exploded perspective view of an expanded part D of FIG. 1;

FIG. 3 is a plan view of electrodes and electrode terminal portions illustrated in FIG. 2;

FIG. 4 is a cross-sectional view taken along line IV-IV in FIG. 2; and

FIG. 5 is a cross-sectional view taken along line V-V in FIG. 2.

### DETAILED DESCRIPTION OF CERTAIN INVENTIVE EMBODIMENTS

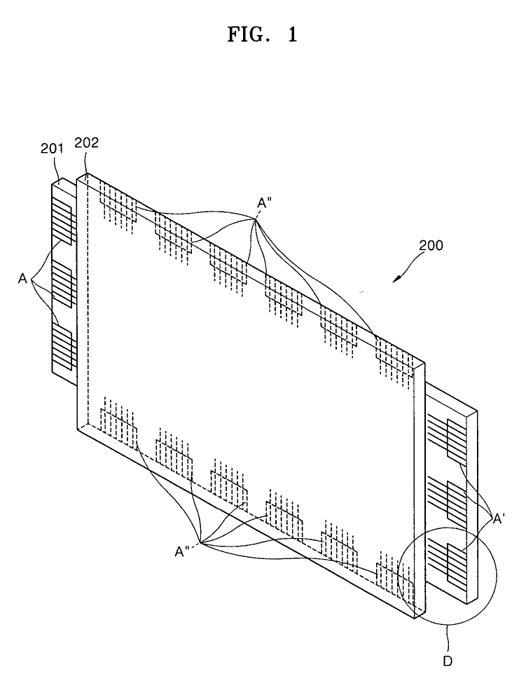

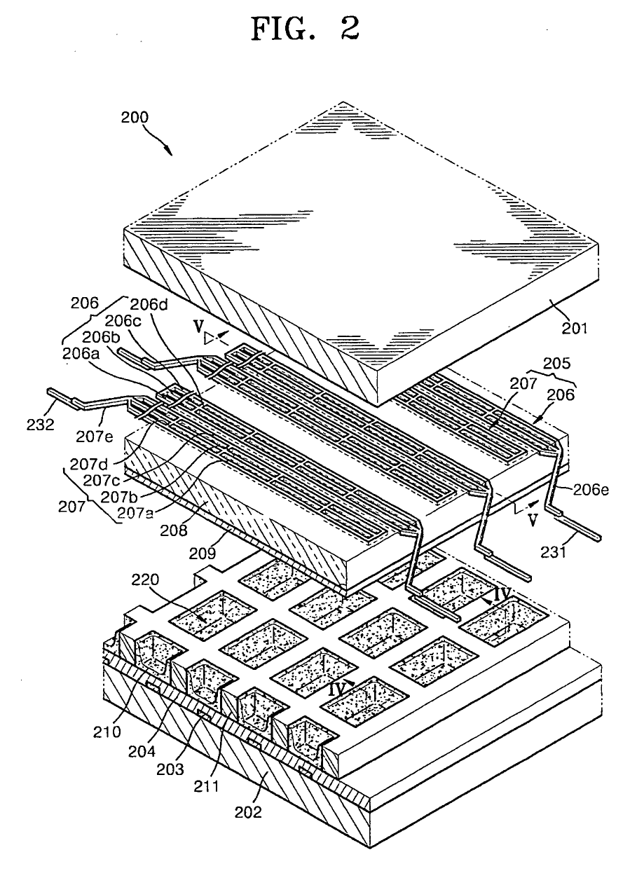

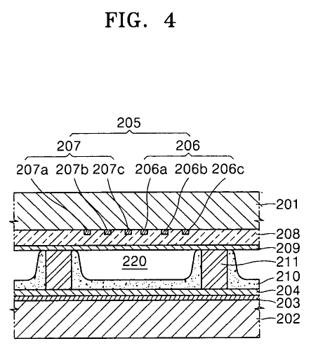

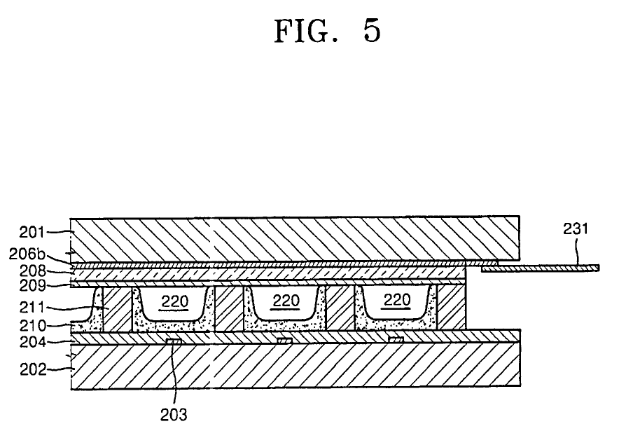

Referring to FIGS. 1 through 5, the plasma display panel 200, which has an electrode terminal structure according to an embodiment, includes a pair of substrates 201 and 202, barrier ribs 211, a plurality of sustain electrode pairs 205, electrode terminal portions A and A′, terminal electrodes 206e and 207e, fluorescent layers 210 and a discharge gas.

The pair of substrates 201 and 202 includes a first substrate 201 and a second substrate 202 which face each other and are disposed a predetermined distance from each other. The first substrate 201 may be formed of glass such that visible rays can travel through the first substrate 201.

In the present embodiment, since the first substrate 201 is substantially transparent, the visible light generated by the fluorescent layer 210 passes through the first substrate 201 and advances to the outside. However, the present invention is not limited to the above structure. In some embodiments, the second substrate 202 may also be substantially transparent, and thus the visible rays can pass through the second substrate 202 and advance to the outside. In such embodiments, either or both of the substrates may comprise substantially transparent materials such as glass, plastic, Plexiglas, or the like.

The barrier ribs 211 define a plurality of discharge cells 220 between the first and second substrates 201 and 202. In some embodiments, the first and second substrates 201 and 202 are larger than the area in which the barrier ribs 211 are formed, thereby sufficiently defining the discharge cells 220 with the barrier ribs 211, and signal transmission units 231 and 232 can be easily installed in portions of the first and second substrate 201 and 202 where the barrier ribs 211 are not disposed.

In the drawings, the cross-section of each of the discharge cells 220 partitioned by the barrier ribs 211 is substantially rectangular, but the present invention is not limited thereto. The cross-sections of the discharge cells 220 can be polygonal, such as triangular or pentagonal, circular, oval, or irregular.

The barrier ribs 211 are interposed between the first substrate 201 and the second substrate 202, and can comprise a dielectric such as PbO, B₂O₃, SiO₂ or the like. The dielectric that forms the barrier ribs 211 prevents damage to the sustain electrode pairs 205 by charged particles colliding with the sustain electrode pairs 205, and induces the charged particles to accumulate wall charges.

The sustain electrode pairs 205, each including a first electrode 206 and a second electrode 207, are disposed on the first substrate 201. However, the present invention is not limited thereto, and the sustain electrode pairs 205 may be disposed elsewhere, for example inside the barrier ribs 211, or on the second substrate 202.

A first dielectric layer 208 is disposed on the first substrate 201 to cover the sustain electrode pairs 205 and prevents the adjacent first electrode 206 and second electrode 207 from being directly charged by each other during discharge and prevents damage to the sustain electrode pairs 205 by the charged particles directly colliding with the sustain electrode pairs 205. Wall charges accumulate on the first dielectric layer 208 by inducing the charge particles. The first dielectric layer 208 may comprise, for example, PbO, B₂O₃, SiO₂, or the like.

A protective layer 209 comprising magnesium oxide (MgO) or the like may be disposed below the first dielectric layer 208. The protective layer 209 prevents damage to the sustain electrode pairs due to sputtering of plasma particles, and lowers a discharge voltage by discharging secondary electrons.

The first electrode 206 is a common electrode and generates a sustain discharge with the second electrode 207. In some embodiments, the first electrode 206 consists of three bus electrodes 206a, 206b, and 206c, but the present invention is not limited thereto. The first electrode 206 may consist of, for example, two bus electrodes or four or more bus electrodes.

The second electrode 207 is a scanning electrode. Moreover, the second electrode 207 and an address electrode 203, which is described below, produce an address discharge for selecting one of the discharge cells 220 in which a gas discharge is to occur. In some embodiments, the second electrode 207 comprises three bus electrodes 207a, 207b, and 207c, but the present invention is not limited thereto. The second electrode 207 may comprise, for example, two bus electrodes or four or more bus electrodes.

The bus electrodes 206a, 206b, 206c; 207a, 207b, and 207c may comprise a metal material, such as silver (Ag), platinum (Pt), palladium (Pd), nickel (Ni), copper (Cu) or the like, and/or a conductive ceramic material such as indium doped tin oxide (ITO), antimony doped tin oxide (ATO), carbon nano tubes (CNT) or the like.

Since costly transparent electrodes with high resistance are not necessarily used, the manufacturing costs may be reduced, and the resistance of the electrodes is lowered, so that a voltage drop is prevented.

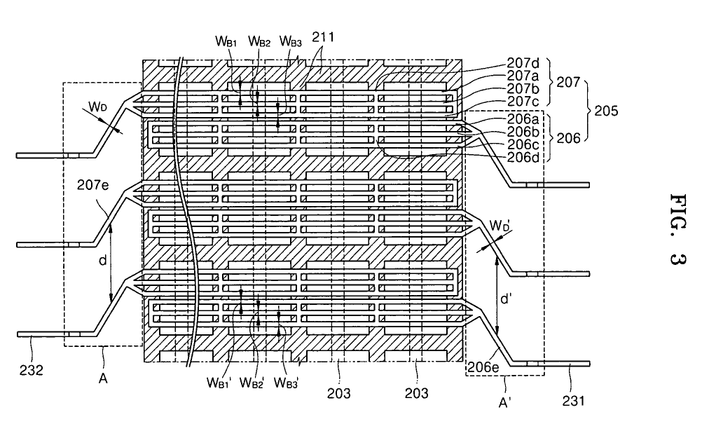

In the embodiment shown in FIG. 3, the first and second electrodes 206 and 207 each comprise three bus electrodes (206a, 206b, and 206c; 207a, 207b, and 207c), each having narrow widths, respectively, and the first and second electrodes 206 and 207 are alternately arranged substantially parallel to each other. A discharge is initiated between the bus electrode 206a of the first electrode 206 and the bus electrode 207c of the second electrode 207 which are closest to each other among the bus electrodes forming the first and second electrodes 206 and 207, and thus a discharge starting voltage can be reduced. The discharge gradually expands to the bus electrodes 206b and 206c of the first electrode 206 and the bus electrodes 207b and 207a of the second electrode 207, and thus the discharge space can be maximized.

The bus electrodes 206a, 206b, and 206c, and 207a, 207b, and 207c forming the individual first electrode 206 and the individual second electrode 207 have narrow widths WB1′, WB2′, and WB3′ and WB1, WB2, and WB3, and thus an aperture ratio is increased, thereby increasing visible light transmission and enhancing luminance.

The electrode terminal portions A and A′ electrically connect the first and second electrodes 206 and 207 to the signal transmission units 231 and 232, respectively. The signal transmission units 231 and 232 transmit electrical signals to the first and second electrodes 206 and 207, and may be, for example, tape carrier packages (TCPs), chip on films (COFs), or flexible printed circuits (FPCs).

Additionally, the electrode terminal portions A and A′ include the terminal electrodes 206e and 207e. The terminal electrode 206e is a line, in which end portions of the bus electrodes 206a, 206b, and 206c forming the first electrodes 206 are connected, and the terminal electrode 207e is a line, in which end portions of the bus electrodes 207a, 207b, and 207c forming the first electrodes 207 are connected. The terminal electrodes 206e and 207e may be fabricated, for example, as thick films using a photosensitive paste, or as thin films by sputtering or evaporating.

With this structure, the first electrodes 206 including the bus electrodes 206a, 206b, and 206c and the second electrodes 207 including the bus electrodes 207a, 207b, and 207c can be respectively electrically connected to the signal transmission units 231 or 232, which may have limited sizes.

In some embodiments, the signal transmission units 231 and 232 respectively contact surfaces of the terminal electrodes 206e and 207e opposite to the surfaces facing the first substrate 201, but the present invention is not limited thereto. The signal transmission units 231 and 232 may be disposed at various different positions.

The width WD′ of the terminal electrode 206e may be less than, equal to, or greater than the sum of the widths WB1′, WB2′, and WB3′ of the bus electrodes 206a, 206b, and 206c, and the width WD of the terminal electrode 207e may be less than, equal to, or greater than the sum of the widths WB1, WB2, and WB3 of the bus electrodes 207a, 207b, and 207c connected to the terminal electrode 207e.

With this configuration, the distance d′ between the terminal electrodes 206e and the distance d between the terminal electrodes 207e is increased. Accordingly, the chance of an occurrence of an electrical short between the terminal electrodes 206e and between terminal electrodes 207e due to contact therebetween is reduced. The widths WD′ and WD of each of the terminal electrodes 206e and between terminal electrodes 207e are reduced and the distance d′ between the terminal electrodes 206e and the distance d between the terminal electrodes 207e are increased, and therefore, the design freedom for connection regions where the terminal electrodes 206e and 207e are respectively connected to the signal transmission unit 231 and 232 is substantially increased. Accordingly, the defect rate when connecting the first and second electrodes 206 and 207 to respectively the signal transmission unit 231 and 232 is reduced.

For example, considering certain manufacturing techniques, the width of each of the terminal electrodes 206e and 207e may be less than 150 μm, but the present invention is not limited thereto.

In some embodiments, the first electrodes 206 may further include short bars 206d that connect the bus electrodes 206a, 206b, and 206c each other, and the second electrodes 207 may further include short bars 207d that connect the bus electrodes 207a, 207b, and 207c each other, but the present invention is not limited thereto.

The short bars 206d and 207d are not necessarily included in the first and second electrodes 206 and 207. Even when some of the bus electrodes 206a, 206b, and 206c, and 207a, 207b, and 207c have defects and are broken, the short bars 206d and 207d can compensate for the defects.

Furthermore, the short bars 206d and 207d may be arranged along the barrier ribs 211 such that the discharge cells 220 are not blocked by the short bars 206d and 207d. Hence, a decrease in the aperture ratio due to the short bars 206d and 207d does not occur.

Although, the short bars 206d and 207d are respectively interposed between all the bus electrodes 206a, 206b, and 206c, and all the bus electrodes 207a, 207b, and 207c in the drawings, the present invention is not limited thereto. The short bars 206d and 207d may, for example, be interposed between some, but not all, of the bus electrodes 206a, 206b, and 206c, and 207a, 207b, and 207c. In some embodiments, the short bars 206d are interposed between bus electrodes 206a, 206b, and 206c, and 207a, 207b, and 207c at locations according to various other configurations.

Moreover, in the embodiment of FIG. 3, the short bars 206d and 207d correspond to each of the barrier ribs 211 in drawings, but the present invention is not limited thereto. The short bars 206d and 207d may correspond to every second or more barrier rib 211, or may correspond to the barrier ribs 211 in various other configurations.

Also, the arrangement of short bars 206d and 207d may be regularly or irregularly arranged.

All the bus electrodes 206a, 206b, and 206c, and 207a, 207b, and 207c included in one sustain electrode pair 205 consisting of the first electrode 206 and the second electrode 207 may intersect the same discharge cell 220, but the present invention is not limited thereto. In FIG. 3, the plurality of bus electrodes 206a, 206b, and 206c forming the first electrode 206 and the plurality of bus electrodes 207a, 207b, and 207c forming the second electrode 207 have widths WB1′, WB2′, WB3′, WB1, WB2, and WB3, respectively, determined such that bus electrodes 206a, 206b, and 206c and 207a, 207b, and 207c intersect one discharge cell 220.

In some embodiments, the second electrodes 207 may intersect the first electrodes 206 extends. In this case, since a discharge cell 220 in which a discharge is initiated can be selected by applying a voltage between the first and second electrodes 206 and 207, the address electrode 203, which is described below, is not necessary.

Moreover, the first electrodes 206 and the second electrodes 207 can extend parallel to each other, and the address electrodes 203 which intersect the first and second electrodes 206 and 207 may be further provided. The discharge cells 220 where discharges occur can be selected by appropriately driving the second electrodes 207 and the address electrodes 203.

The address electrodes 203 may be disposed on the second substrate 202, but the present invention is not limited thereto. The address electrodes 203 may be arranged in various ways, for example, inside the barrier ribs 211.

A second dielectric layer 204 may cover the address electrodes 203. The second dielectric layer 204 comprises a dielectric which can prevent the address electrodes 203 from being damaged due to positive ions or electrons colliding with the address electrodes 203, and can induce electrons. The dielectric may comprise PbO, B₂O₃, SiO₂, or the like.

In some embodiments, the fluorescent layer 210 is formed on a bottom surface of the discharge cell 220 and sides of the barrier rib 221, but the present invention is not limited thereto. The fluorescent layer 210 may be formed in any portion, such as the top surface, of the discharge cell 220.

Such a fluorescent layer 210 includes a compound that receives ultra-violet light and generates visible light. A red fluorescent layer formed in a red luminous discharge cell includes a fluorescent material such as Y(V,P)04:Eu, a green fluorescent layer formed in a green luminous discharge cell includes a fluorescent material such as Zn₂SiO₄:Mn, and a blue fluorescent layer formed in a blue luminous discharge cell includes a fluorescent material such as BAM:Eu.

A discharge gas such as Ne, Xe, or the like is injected into the discharge cells 220 defined by the first substrate 201, the second substrate 202 and the barrier ribs 211.

Operation processes of an embodiment of a plasma display panel 200 employing an electrode terminal structure according to an embodiment will be described.

First, when an address voltage is applied between the address electrode 203 and the second electrode 207, an address discharge occurs, and, consequently, the discharge cell 220 in which a sustain discharge is to occur is selected. When this occurs, the address voltage is applied to the second electrode 207 via the signal transmission unit 232 and the terminal electrode 207e.

Then, when a discharge sustain voltage is applied between the first electrode 206 and the second electrode 207 via the signal transmission units 231 and 232 and the terminal electrodes 206e and 207e, the wall charges accumulated on the first electrode 206 and the second electrode 207 move, resulting in a sustain discharge, which excites the discharge gas in the discharge cell 220. The discharge gas emits ultra-violet rays when the energy level of the discharge gas returns to its ground state.

The ultra-violet rays excite the fluorescent substance 210 coated on the discharge cells 220, and the fluorescent substance 210 emits visible light as the energy level of the excited fluorescent substance 210 is lowered, and the radiated visible light passes through the first substrate 201 and travels to the outside, thereby forming an image visible to a user.

According to some embodiments, in an electrode terminal structure and a plasma display panel employing the same, terminal electrodes disposed on electrode terminal portions are formed such that the width of each of the terminal electrodes is not greater than the sum of widths of a plurality of bus electrodes connected to the terminal electrode, and thus an electrical short between the terminal electrodes is prevented and a connecting region is easily designed.

Furthermore, according some embodiments, sustain electrodes include only bus electrodes and not transparent electrodes, and thus the manufacturing costs can be reduced, and the resistance of the sustain electrodes is lowered, thus preventing a voltage drop.

Furthermore, since the sustain electrodes include only bus electrodes and not transparent electrodes, a discharge starting voltage can be lowered, a discharge space can be maximized, and an aperture ratio can be increased.

While the present invention has been particularly shown and described with reference to exemplary embodiments thereof, it will be understood by those of ordinary skill in the art that various changes in form and details may be made therein without departing from the spirit and scope of the present invention.

What is claimed is:

1. An electrode terminal structure of a plasma display panel, the electrode terminal structure comprising:
a plurality of first electrodes, each electrode including a plurality of bus electrodes;
a plurality of second electrodes, disposed so as to correspond to the first electrodes, each of the second electrodes including a plurality of bus electrodes;
a plurality of terminal electrodes which are electrically connected to the first electrodes and to the second electrodes, respectively, and which extend as single lines, each connected to the bus electrodes of one of the plurality of first electrodes or connected to the bus electrodes of one of the second electrodes, the width of each of the terminal electrodes being less than or equal to the sum of the widths of the bus electrodes to which each terminal electrode is connected.

2. The electrode terminal structure of claim 1, wherein the width of each of the terminal electrodes is less than or equal to 150 μm.

3. The electrode terminal structure of claim 1, wherein at least one of the first electrodes and the second electrodes further comprise short bars that connect two or more of the associated plurality of bus electrode.

4. The electrode terminal structure of claim 1, wherein the second electrodes intersect the first electrodes extend.

5. The electrode terminal structure of claim 1, further comprising address electrodes which intersect the first electrodes and the second electrodes, wherein the first electrodes and the second electrodes are substantially parallel.

6. The electrode terminal structure of claim 1, wherein the terminal electrodes are electrically connected to a signal transmission unit configured to transmit electric signals to the first electrodes or the second electrodes.

7. A plasma display panel comprising:
a first substrate;
a second substrate which faces and is separated from the first substrate;
a plurality of barrier ribs which are interposed between the first substrate and the second substrate;
a plurality of discharge cells configured to contain a discharge and having a plurality of fluorescent layers which are disposed in the discharge cells;
a plurality of sustain electrodes which are disposed between the first substrate and the second substrate, the sustain electrodes being configured to initiate a gas discharge in the discharge cells by an interaction between the sustain electrodes, wherein the plurality of sustain electrodes comprises a plurality of first electrodes and a plurality of second electrodes, which each comprise a plurality of bus electrodes; and
a plurality of terminal electrodes which are electrically connected to the first electrodes and to the second electrodes, respectively, and which extend as single lines, each terminal electrode connected to the bus electrodes of one of the first and second electrodes, the width of each of the terminal electrodes being less than or equal to the sum of the widths of the bus electrodes to which each terminal electrode is connected;
fluorescent layers which are disposed in the discharge cells; and
a discharge gas which is filled in the discharge cells.

8. The plasma display panel of claim 7, wherein the width of each of the terminal electrodes is less than or equal to 150 μm.

9. The plasma display panel of claim 7, wherein at least one of the first electrodes and the second electrodes further comprise short bars that connect two or more of the associated plurality of bus electrodes included in each of the first electrodes and the second electrodes each other.

10. The plasma display panel of claim 8, wherein the short bars are disposed along the barrier ribs that extend perpendicular to the bus electrodes.

11. The plasma display panel of claim 7, wherein the bus electrodes of each pair of sustain electrodes intersect the same discharge cells.

12. The plasma display panel of claim 7, wherein the sustain electrodes intersect the direction of the first substrate.

13. The plasma display panel of claim 7, wherein the second electrodes intersect the direction of the first electrodes.

14. The plasma display panel of claim 7, further comprising address electrodes which intersect the first electrodes and the second electrodes, wherein the first electrodes and the second electrodes are substantially parallel.

15. The plasma display panel of claim 14, wherein the address electrodes are disposed on the second substrate.

16. The plasma display panel of claim 7, wherein the terminal electrodes are electrically connected to a signal transmission unit configured to transmit electric signals to the first electrodes, the second electrodes.

17. An electrode terminal structure of a plasma display panel, the electrode terminal structure comprising:
a first electrode connecting to a plurality of discharge cells, and including a first plurality of bus electrodes; and
a second electrode connecting to the plurality of discharge cells, and including a second plurality of bus electrodes;
a plurality of terminal electrodes which are electrically connected to the first electrodes and to the second electrodes, respectively, and which extend as single lines, each connected to the bus electrodes of one of the plurality of first electrodes or connected to the bus electrodes of one of the second electrodes.

18. The electrode terminal structure of claim 17, wherein the width of each of the terminal electrodes is less than or equal to the sum of the widths of the bus electrodes to which each terminal electrode is connected.

19. The electrode terminal structure of claim 17, wherein at least one of the first electrode and the second electrode further comprises short bars that connect two or more of the associated plurality of bus electrode.

20. The electrode terminal structure of claim 17, wherein the first electrodes and the second electrodes are substantially parallel.
